(19) United States
(12) Patent Application Publication
(10) Pub. No.: US 2015/0108858 A1
(43) Pub. Date: Apr. 23, 2015

(54) FAN MOTOR APPARATUS HAVING IMPROVED HEAT-RADIATION PERFORMANCE

(71) Applicant: DONGYANG MECHATRONICS CORP., Incheon (KR)

(72) Inventor: Sang Gil Kim, Incheon (KR)

(73) Assignee: DONGYANG MECHATRONICS CORP., Incheon (KR)

(21) Appl. No.: 14/508,890

(22) Filed: Oct. 7, 2014

(30) Foreign Application Priority Data
Oct. 23, 2013 (KR) 10-2013-0126748

(51) Int. Cl. H02K 5/18; H02K 9/00

(52) U.S. Cl. CPC H02K 5/18; H02K 9/00
USPC 310/59

(57) ABSTRACT

A fan motor apparatus having an improved heat-radiation performance includes a stator including an electronic device; a central shaft which is fixed onto the upper surface of the stator; a rotator mounted rotatably with the respect to the stator by being rotatably coupled to the central shaft; a heat-radiating fin portion provided on an inner surface of the rotator to generate wind toward the stator when the rotator rotates; and an cooling fin combined air flow guide formed on a surface of the stator to increase a heat exchange area for a heat exchange between the air generated by the heat-radiation fin portion and the air inside the stator; and at the same time guide the air from the exterior of the stator toward the central shaft so that the air is introduced into the rotator via a lower surface of the rotator.

### RELATED APPLICATIONS

This application claims the benefit of Korean Patent Application No. 10-2013-0126748, filed on Oct. 23, 2013, in the Korean Intellectual Property Office, the disclosure of which is incorporated herein in its entirety by reference.

### BACKGROUND

1. Field

One or more embodiments of the present invention relate to a fan motor apparatus.

2. Description of the Related Art

In general, a fan motor apparatus is provided to cool a component that generates a heat, such as car radiators, freezers, refrigerators, and air-conditioning equipment.

A general structure of the fan motor apparatus includes a motor unit generating a rotational driving force, and a blowing fan that is coupled to the motor unit and blows air.

An example of such a fan motor apparatus is disclosed in Korea Utility Model Publication No. 2008-0000346.

In general, the motor unit of the fan motor apparatus includes a rotator and a stator. An electronic circuit that is a control apparatus to supply current to the motor unit and to control the motor unit is disposed inside the stator. The electronic circuit of the control apparatus is manufactured by mounting a plurality of electronic devices on the surface of a printed circuit board (PCB).

As the fan motor apparatus is driven, heat is generated in the electronic devices mounted on the surface of the PCB. Therefore, to effectively cool the heat generated in the electronic devices, the fan motor apparatus includes a plurality of radiating fins that make a heat exchange area for exchange between heat and outside air be as wide as possible on the surface of a rotator housing.

Conventional heat radiating fins 1 are shown in FIG. 1. However, the conventional heat radiating fins 1 only widen the heat exchange area and are hard to directly introduce the outside air into a motor. Thus, optimum cooling effect does not occur. In particular, as brushless motors have recently been applied to fan motor apparatuses, electronic devices are also disposed inside a rotator as well as a stator. In this case, cooling the electronic devices disposed inside the rotator and the stator is newly needed, and a need to improve the cooling performance of a motor unit is increasing.

### SUMMARY

One or more embodiments of the present invention include a fan motor apparatus having an improved heat-radiation performance by improving a radiating fin structure of a motor unit so as to effectively cool the heat generated in electronic devices disposed inside the motor unit

Additional aspects will be set forth in part in the description which follows and, in part, will be apparent from the description, or may be learned by practice of the presented embodiments.

According to one or more embodiments of the present invention, a fan motor apparatus having an improved heat-radiation performance includes a stator including an electronic device; a central shaft fixed onto upper surface of the stator so as to protrude from the upper surface of the stator; a rotator mounted rotatably with respect to the stator by being rotatably coupled to the central shaft; a heat-radiation fin portion provided on an inner surface of the rotator to generate wind toward the stator when the rotator rotates; and an cooling fin combined air flow guide formed on the surface of the stator to increase a heat exchange area for a heat exchange between air generated by the heat radiation fin portion and the air inside the rotator , and at the same time guide air from the exterior of the stator toward the central shaft so that the air is induced into the rotator via a lower surface of the rotator.

A plurality of the cooling fin combined air flow guides may be arranged along a circumference of the stator, based on the central shaft.

Each of the cooling fin combined air guides may have a cross-section that narrows in a direction from an exterior edge of the stator to a center of the stator.

### BRIEF DESCRIPTION OF THE DRAWINGS

These and/or other aspects will become apparent and more readily appreciated from the following description of the embodiments, taken in conjunction with the accompanying drawings in which:

FIG. 1 is a diagram for explaining the problem of a conventional radiating fin structure;

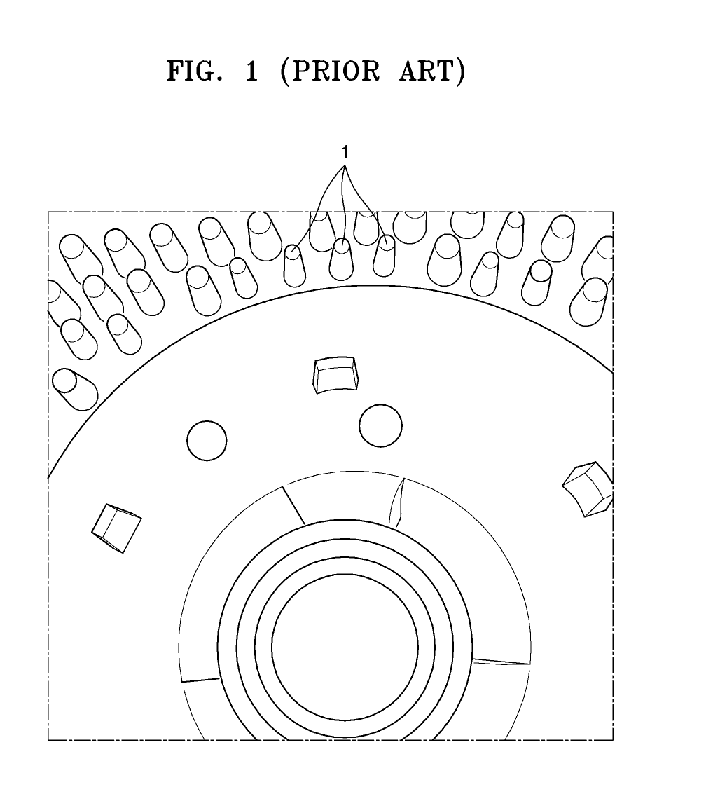

FIG. 2 is a schematic perspective view of a fan motor apparatus according to an exemplary embodiment of the invention;

FIG. 3 is a perspective view illustrating a structure of a stator included in the fan motor apparatus shown in FIG. 2; and

FIG. 4 is a sectional view taken along line IV-IV shown in FIG. 2.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description.

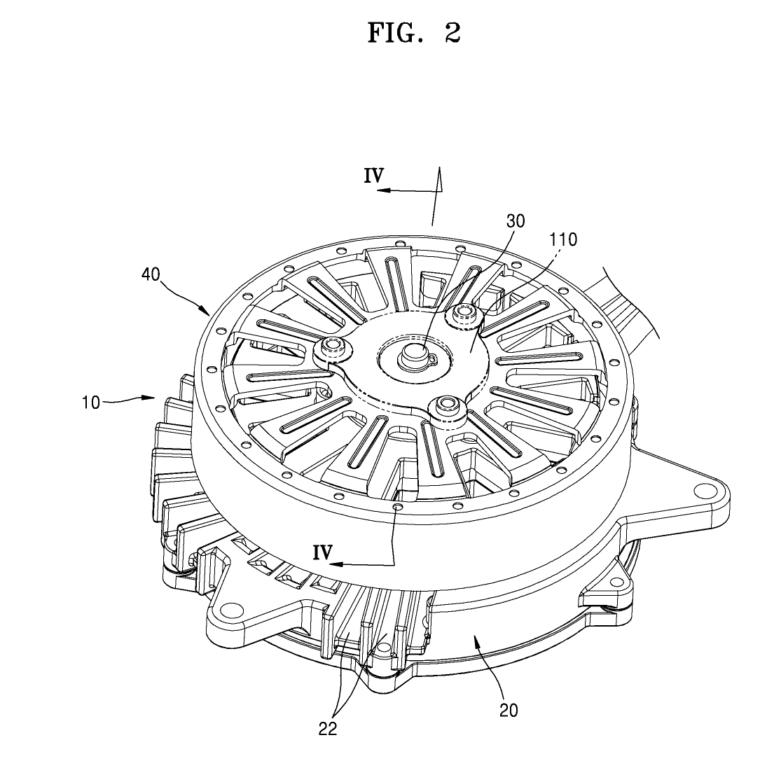

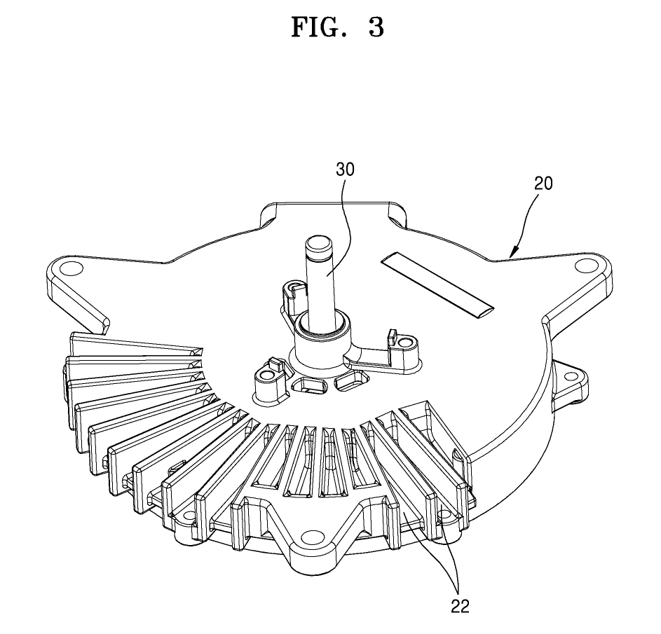

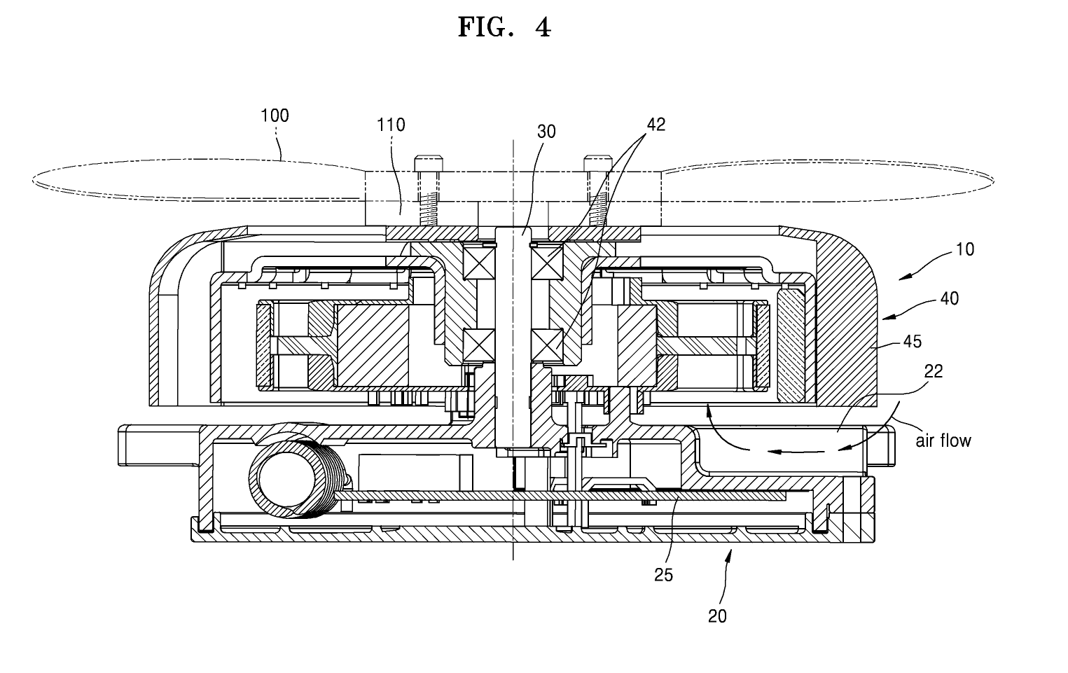

FIG. 2 is a schematic perspective view of a fan motor apparatus 10 according to an exemplary embodiment of the invention. FIG. 3 is a perspective view showing a structure of a stator 20 included in the fan motor apparatus 10 shown in FIG. 2. FIG. 4 is a sectional view taken along line IV-IV shown in FIG. 2.

Referring to FIGS. 2 through 4, the fan motor apparatus 10 having an improved heat-radiation performance (hereinafter, referred to as “a fan motor apparatus 10”) includes the stator 20, a central shaft 30, and a rotator 40.

The stator 20 is a non-rotating part. The stator 20 includes an electronic device. The electronic device may be mounted on a printed circuit board (PCB) 25 and may be provided inside the stator 20. The electronic device generates heat during its operation. When the electronic device over-heats, the performance of the fan motor apparatus 10 may deteriorate or the fan motor apparatus 10 may not operate.

A plurality of cooling fin combined air flow guides 22 are formed on an upper surface of the stator 20. The cooling fin combined air flow guides 22 are provided to effectively cool the heat generating in the electronic device mounted inside the stator 20. The structure of the cooling fin combined air flow guides 22 will be described in detail later.

The central shaft 30 is fixed to an upper surface of the stator 20. The central shaft 30 is disposed to protrude from the upper surface of the stator 20. The central shaft 30 is a shaft on which the rotator 40, which will be described later, rotates. The cross section of the central shaft 30 is circular.

The rotator 40 is rotatably coupled to the central shaft 30. The rotator 40 includes a permanent magnet. Accordingly, the rotator 40 is provided to be rotatable with respect to the stator 20. In more detail, as shown in FIG. 4, the rotator 40 is rotatably coupled to the central shaft 30 by using bearings 42. The principle in which the rotator 40 rotates by an electromagnetic interaction with the stator 20 is the same as that for a conventional motor, and thus a detailed description of an electrical aspect thereof will be omitted.

A heat radiation fin portion 45 is provided inside the rotator 40. The heat radiation fin portion 45 generates wind by flowing air toward the stator 20 when the rotator 40 rotates. In more detail, the heat radiation fin portion 45 is a fan-shape structure that protrudes inwardly from an inner circumferential surface of a frame that constitutes the outskirt of the rotator 40. A plurality of heat radiation fin portions 45 are formed along the inner circumferential surface of the frame of the rotator 40 such that the heat radiation fin portions 45 are spaced apart from each other. In addition, the bottom of the frame of the rotator 40 is formed to be open. Therefore, while the rotator 40 is rotating, the heat radiation fin portions 45 generate wind by flowing air toward the area below the rotator 40.

A blowing fan 100 may be combined with the upper portion of the rotator 40 via a fastening bush 110. The blowing fan 100 may receive a rotational driving force from the fan motor apparatus 10 and cool a component such as a car radiator.

The present invention is not focused on an operational effect of the blowing fan 100, but on how to effectively cool the heat generated in the components provided inside the stator 20 and the rotator 40 included in the fan motor apparatus 10. Thus a detailed description of the blowing fan 100 will be omitted.

A structure of the cooling fin combined air flow guides 22 will now be described in more detail. The structure of the cooling fin combined air flow guides 22 will be easily understood by referring to FIG. 2. As described above, a plurality of cooling fin combined air flow guides 22 are provided. The cooling fin combined air flow guides 22 are arranged along the circumference of the stator 20.

In more detail, the plurality of cooling fin combined air flow guides 22 are formed along the circumference of the stator 20, based on the central shaft 30. Each of the cooling fin combined air flow guides 22 is provided as a groove that is formed long on the upper surface of the stator 20. In more detail, each of the cooling fin combined air flow guides 22 is a groove formed long from an outer edge of the stator 20 toward the central shaft 30, mounted on the stator 20, on the upper surface of the stator 20. The cooling fin combined air flow guides 22 have a concave-convex cross-section in order to broaden a heat exchange area for a heat exchange between the exterior and interior of the stator 20.

In more detail, the cooling fin combined air flow guides 22 are grooves which are open toward the outer edge of the stator 20. The cooling fin combined air flow guides 22 are also grooves of which tops are open. In addition, it is preferable that each of the cooling fin combined air flow guides 22 has a cross section that narrows in a direction from the outer edge of the stator 20 toward the center thereof.

Portions of the inner walls of the cooling fin combined air flow guides 22 that are near the central shaft 30 enable the air induced from the exterior of the stator 20 along the cooling fin combined air flow guides 22 to be introduced into the rotator 40 via the lower part of the rotator 40.

The cooling fin combined air flow guides 22 increases a heat exchange area for a heat exchange between the wind generating by the heat radiation fin portions 45 and the air inside the rotator 40. At the same time, the cooling fin combined air flow guides 22 guide air from the exterior of the stator 20 toward the central shaft 30 so that the air is introduced into the rotator 40 via the bottom of the rotator 40.

Hereinafter, the operational effect of the present invention that the heat radiation fin portions 45 and the cooling fin combined air flow guides 22 included in the fan motor apparatus 10 cool the stator 20 and the rotator 40 will be described in detail.

As the fan motor apparatus 10 operates, the rotator 40 rotates about the central shaft 30. As the rotator 40 rotates, the heat radiation fin portions 45 provided in the rotator 40 also rotate. The heat radiation fin portions 45 flow air toward the area below the rotator 40 to generate wind. The wind generated by the heat radiation fin portions 45 reaches the cooling fin combined air flow guides 22. The wind enters the cooling fin combined air flow guides 22 and moves toward the center of the stator 20 along the groove unit as shown in FIG. 4 and at the same time exchanges heat with heated air within the stator 20. Therefore, the heat generated in the electronic devices provided inside the stator 20 is effectively cooled.

At the same time, the air that has passed through the cooling fin combined air flow guides 22 enters the rotator 40 via the lower part of the rotator 40. The air entered in the rotator 40 circulates along the rotator 40 and is discharged from the rotator 40 via the upper surface of the rotator 40. Accordingly, the heat generated in the components disposed inside the rotator 40 is radiated.

Since outside air is continuously introduced into the cooling fin combined air flow guides 22 from the exterior of the stator 20 by the heat radiation fin portions 45, both the rotator 40 and the stator 20 may be effectively cooled while the fan motor apparatus 10 is operating.

As described above, according to one or more of the above embodiments of the present invention, a fan motor apparatus increases a contact area between wind generated by a heat-radiation fin portion included in a rotator and the air inside a stator by using a cooling fin combined air flow guide included in the stator, and also cools both the rotator and the stator by inducing air from the exterior of the stator and providing the air to the rotator via the lower surface of the rotator by using the cooling fin combined air flow guide, thereby effectively cooling the heat generated in electronic devices disposed inside a motor.

It should be understood that the exemplary embodiments described therein should be considered in a descriptive sense only and not for purposes of limitation. Descriptions of features or aspects within each embodiment should typically be considered as available for other similar features or aspects in other embodiments.

While one or more embodiments of the present invention have been described with reference to the figures, it will be understood by those of ordinary skill in the art that various changes in form and details may be made therein without departing from the spirit and scope of the present invention as defined by the following claims.

What is claimed is:

1. A fan motor apparatus having an improved heat-radiation performance, the fan motor apparatus comprising:
a stator including an electronic device;
a central shaft fixed onto an upper surface of the stator so as to protrude from the upper surface of the stator;
a rotator mounted rotatably with respect to the stator by being rotatably coupled to the central shaft;
a heat-radiation fin portion provided on an inner surface of the rotator to generate wind toward the stator when the rotator rotates; and
an cooling fin combined air flow guide formed on a surface of the stator to increase a heat exchange area for a heat exchange between air generated by the heat radiation fin portion and the air inside the rotator and at the same time guide air from the exterior of the stator toward the central shaft so that the air is introduced into the rotator via a lower surface of the rotator.

2. The fan motor apparatus of claim 1, wherein a plurality of the cooling fin combined air flow guides are arranged along a circumference of the stator, based on the central shaft.

3. The fan motor apparatus of claim 2, wherein each of the cooling fin combined air flow guides has a cross-section that narrows in a direction from an exterior edge of the stator to a center of the stator.

4. The fan motor apparatus of claim 1, wherein each of the cooling fin combined air flow guides has a cross-section that narrows in a direction from an exterior edge of the stator to a center of the stator.
